(19) United States
(12) Patent Application Publication
(10) Pub. No.: US 2014/0325195 A1
(43) Pub. Date: Oct. 30, 2014

(54) METHOD FOR UNLOCKING A MOBILE DEVICE

(71) Applicants: Ruijun Xu, Beijing (CN); Fei Xu, Beijing (CN); Fan Jin, Beijing (CN); Feng Liang, Beijing (CN); Tian Ren, Beijing (CN); Weixing Li, Beijing (CN); Guangdou Sun, Beijing (CN); Zhifan Qin, Beijing (CN); Wanqiang Li, Beijing (CN); Jiangji Huang, Beijing (CN)

(72) Inventors: Ruijun Xu, Beijing (CN); Fei Xu, Beijing (CN); Fan Jin, Beijing (CN); Feng Liang, Beijing (CN); Tian Ren, Beijing (CN); Weixing Li, Beijing (CN); Guangdou Sun, Beijing (CN); Zhifan Qin, Beijing (CN); Wanqiang Li, Beijing (CN); Jiangji Huang, Beijing (CN)

(73) Assignee: Xiaomi Inc., Haidian District, Geijing (CN)

(21) Appl. No.: 14/128,761

(22) PCT Filed: Mar. 19, 2012
(86) PCT No.: PCT/CN2012/072554

§ 371 Date: Jun. 19, 2014

(30) Foreign Application Priority Data
Jun. 30, 2011 (CN) 201110181927.6

(51) Int. Cl. G06F 9/00

(52) U.S. Cl. CPC G06F 9/00
USPC 713/1

(57) ABSTRACT

The present disclosure is drawn to a method for unlocking a mobile device. The method comprises the steps of adopting a configuration file to define an operational input for unlocking the mobile device, adopting the configuration file to define at least one animation and/or effect, adopting the configuration file to establish a relationship between the operational input and the at least one animation and/or effect, and triggering the animation and/or effect when unlocking the mobile device. The technical scheme of the present disclosure combines the operational input for unlocking the mobile device with the animation and/or effect, helping to improve the user experience of unlocking a mobile device.

### FIELD OF THE INVENTION

The present disclosure relates to novel mobile device software technology and its real world applications, and more particularly to a method for allowing a user to unlock a mobile device.

### BACKGROUND OF THE INVENTION

With the development of mobile communication technology, mobile devices have become indispensable in the lives of many. Consumers gather information, conduct office work, and entertain themselves through their mobile devices and the software running thereon. However, given the enormous install base of mobile device users, the variety of types and models of mobile devices are relatively limited. Therefore, the personalization and personality of a user's mobile device is often limited to switching between various third-party applications on the mobile device. For example, when in a locked state, mobile devices often present the user with a black or static screen. Further, the screen of the mobile device undergoes little change during unlocking operation. As a result, the user experience for consumer is quickly grows stale.

### SUMMARY OF THE INVENTION

The purpose of the present disclosure is to provide a method for unlocking a mobile device, the method helping to improve the overall presentation of unlocking mobile device, and increase the users' enjoyment and sense of ownership of their mobile device.

In one embodiment, the present disclosure adopts the following technical scheme, a method for unlocking a mobile device that includes: adopting a configuration (hereinafter, “config”) file to define an operational input for unlocking the mobile device; performing an unlocking operation utilizing the operational input; and unlocking the mobile device upon performing the unlocking operation.

In a further embodiment, the above method further includes: adopting the config file to define an animation, effect, or combinations thereof; adopting the config file to establish a relationship between the operational input and animation, effect, or combinations thereof; and unlocking the mobile device and performing the animation and/or effect for the user when performing the unlocking operation and utilizing the operational input.

In one embodiment, the config file is an XML file.

In another embodiment, the operational input is an interaction between the user and the screen of the mobile device. In some embodiments, the interaction involves clicking the screen. In one embodiment, the interaction involves touching the screen. In a further embodiment, the interaction involves sliding the user's fingertip along a preset path on the screen.

In some embodiments, the operational input is an input from a sensor in the mobile device.

In a further embodiment, the sensor of the mobile device includes a gravity sensor, a gyroscope, a compass, a light sensor, combinations thereof, and the like.

Consistent with the technical scheme of the present disclosure, the operational input for unlocking the mobile device combines with an animation and/or effect to improve the presentation effect of unlocking the mobile device and increase a user's overall enjoyment of their mobile device.

### BRIEF DESCRIPTION OF THE DRAWING

FIG. 1 shows a method of unlocking a mobile device consistent with an embodiment of the present invention.

### DESCRIPTION OF THE EMBODIMENTS

An embodiment of the method of unlocking a mobile device herein disclosed is further described with reference to the accompanying drawing.

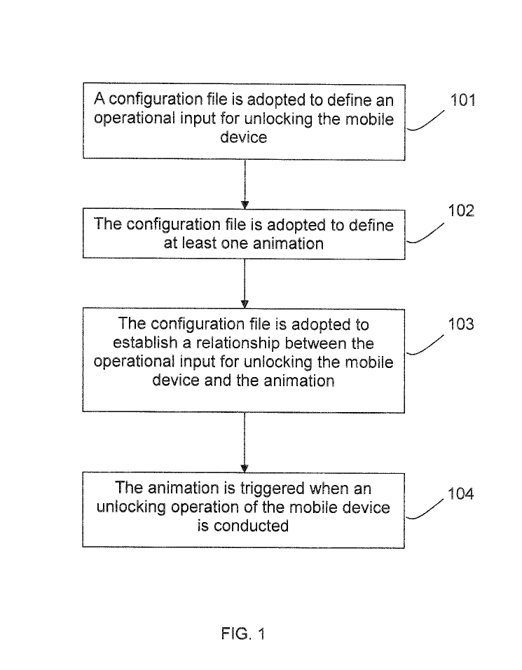

FIG. 1 shows an embodiment of the instant method of unlocking a mobile device comprising the following steps.

At step 101, a config file is adopted to define an operational input for unlocking the mobile device. In a further embodiment, the config file is an XML file.

In one embodiment, the operational input is performed by contacting a screen of the mobile device, such as by clicking or touching the screen. In a further embodiment, contacting the screen further comprises the sliding of a user's finger along a preset path. In another embodiment, the operational input is an input from the mobile device sensor, such as a gravity sensor, a gyroscope, a compass, a light sensor, combinations thereof, and the like.

At step 102, the config file is adopted to define at least one animation, effect, and combinations thereof. In one embodiment, the config file is an XML file.

At step 103, the config file is adopted to establish a relationship between the operational input and the animation, effect, and combinations thereof. In one embodiment, the config file is an XML file.

At step 104, the animation and/or effect is triggered when the operational input is performed by a user.

In one embodiment, when the mobile device is in a locked state, an icon such as a slider on the screen is moved along a predefined path. In another embodiment, the slider does not move along a predefined path. Movement of the slider also triggers an animation, on the mobile device. In one embodiment, the animation is a portrait of a face or head which animates on the screen to greet the user. In a further embodiment, moving the slider across the screen faster causes an increase in the speed and/or magnitude of the animation of the animated face or head portrait.

In another embodiment, when the screen of the mobile device is in a locked state, an image appears on the screen and animates by stretching itself on the screen at a preset time or in conjunction with the ringing of an alarm.

In a further embodiment, unlocking of the mobile device could be facilitated by an operational input of a gravity sensor. In this embodiment, the mobile device is unlocked when a user shakes the mobile device 3 times in succession.

The above is a detailed description of the technical features of the present disclosure based on exemplary embodiments. However, it should be appreciated that the present disclosure envisions a variety of additional embodiments and various modifications by those skilled in the art, and all such variations or changes shall be embraced within the scope of the following claims.

1. A method for unlocking a mobile device, comprising:
adopting a configuration file to define an operational input for unlocking the mobile device;
performing an unlocking operation utilizing the operational input; and
unlocking the mobile device upon performing the unlocking operation.

2. The method of claim 1, further comprising the steps of:
adopting the configuration file to define at least one animation, effect, and combinations thereof;
adopting the configuration file to establish a relationship between the operational input and the at least one of the animation, effect, and combinations thereof;
performing the at least one of the animation, effect, and combinations thereof when performing the unlocking operation.

3. The method of claim 1, wherein the configuration file is an XML file.

4. The method of claim 1, wherein the operational input is selected from a group consisting of: clicking a screen, touching a screen, sliding along a preset path on a screen, and combinations thereof.

5. The method of claim 1, wherein the operational input is an input of a sensor in the mobile device.

6. The method of claim 5, wherein the sensor is selected from a group consisting of: a gravity sensor, a gyroscope, a compass, a light sensor, and combinations thereof.

7. The method of claim 5 wherein the sensor is a clock comprising an alarm, wherein time is the operational input and the passage of time after a triggering of the alarm is the unlocking operation.

8. The method of claim 6, wherein the sensor is a gravity sensor, wherein the operational input is accelerations of the mobile device by a user and a series of accelerations is the unlocking operation.

9. The method according to claim 2, wherein the animation, effect, and combinations thereof have a magnitude proportional to a speed at which the unlocking operation is performed, and further comprising the following step:
increasing the magnitude of the animation, effect, and combinations thereof as the speed of the unlocking operation increases.

10. A method for unlocking a mobile device, comprising the steps of:
adopting a configuration file to define an operational input, an unlocking operation, an animation having a magnitude, and a relationship between the operational input, the unlocking operation, and the animation, wherein the configuration file is an XML file;
receiving an operational input;
performing an unlocking operation in response to the operational input;
performing an animation in connection with performance of the unlocking operation;
increasing the magnitude of the animation in response to an increase in a speed of the unlocking operation; and
unlocking the mobile device,
wherein the animation is selected from the group consisting of: an animation, an effect, and combinations thereof.

11. The method according to claim 10, wherein the operational input is an input of a sensor within the mobile device.

12. The method according to claim 11, wherein the sensor is selected from a group consisting of: a gravity sensor, a gyroscope, a compass, a light sensor, and combinations thereof.

13. A system for unlocking a mobile device, the system comprising:
a storage medium, the storage medium comprising a configuration file and at least one animation file defining an animation, effect, or combinations thereof, wherein the configuration file defines an operational input, an unlocking operation, and assigns an animation to the unlocking operation;
a sensor for providing the operational input;
software executing on the storage medium for recognizing the operation input and correlating the operational input with the unlocking operation; and
software executing on the storage medium for performing the animation in response to the unlocking operation.

14. The system according to claim 13, wherein the sensor is selected from the group consisting of: a gravity sensor, a gyroscope, a compass, a light sensor, and combinations thereof.

15. The system according to claim 13, wherein the animation, effect, or combinations thereof have a magnitude proportional to a speed at which the unlocking operation is performed, and wherein the magnitude increases as the speed of the unlocking operation increases.

16. The system according to claim 13, wherein the configuration file is an XML file.
